(19) United States
(12) Patent Application Publication
(10) Pub. No.: US 2013/0085829 A1
(43) Pub. Date: Apr. 4, 2013

(54) PAPER COUPON FRAUD DETECTION

(71) Applicant: INMAR, INC., Winston-Salem, NC (US)

(72) Inventors: MICHAEL J. KAVIS, Parrish, FL (US); STEVEN EDMON GOFORTH, Tampa, FL (US); WILLIAM M. CATANIA, Winston-Salem, NC (US)

(73) Assignee: INMAR, INC., Winston-Salem, NC (US)

(21) Appl. No.: 13/630,989

(22) Filed: Sep. 28, 2012

Related U.S. Application Data
(60) Provisional application No. 61/541,316, filed on Sep. 30, 2011.

(51) Int. Cl. G06Q 30/02

(52) U.S. Cl. 705/14.26

(57) ABSTRACT

A computer may receive a product code from a POS device. Further, the computer may compare the product code to identifiers for a plurality of fraudulent coupons comprising universal product codes (UPCs) of the fraudulent coupon and a trigger item code of the fraudulent coupon. Responsive to a match between the product code and the identifier of at least one fraudulent coupon, the computer may obtain information associated with the fraudulent coupon. Further, the computer may transmit the information of the at least one fraudulent coupon to the POS device. The POS device may receive the information of the at least one fraudulent coupon and compare the information with a UPC of a coupon scanned at the POS device. Responsive to a match between the fraudulent coupon information and the UPC of the coupon, the computer may generate an alert to notify that the scanned coupon is a fraudulent coupon.

### CROSS REFERENCE TO RELATED APPLICATIONS

This application claims priority to U.S. Provisional Patent Application No. 61/541,316 filed Sep. 30, 2011 in the names of Michael J. Kavis, Steven Edmon Goforth, and William M. Catania and entitled “Method and System for Detecting Paper Coupon Fraud,” the entire contents of which are hereby incorporated herein by reference.

This application is related to U.S. patent application Ser. No. 12/783,762, filed May 20, 2010, published as U.S. Publication Number 2010/0299198, in the names of William M. Catania, Michael J. Kavis, and Gregory H. Rapp and entitled “Message Broker for Redemption of Digital Incentives,” and U.S. patent application Ser. No. 12/783,666, filed May 20, 2010, published as U.S. Publication Number 2010/0299266, in the names of William M. Catania, Michael J. Kavis, and Gregory H. Rapp and entitled “Digital Incentives Issuance, Redemption, and Reimbursement,” the entire contents of which are hereby incorporated herein by reference.

### FIELD OF INVENTION

This edisclosure relates generally to a technical field of fraud detection and, in one example embodiment, to a system, method and an apparatus for paper coupon fraud detection.

### BACKGROUND

Businesses may use coupons (e.g., paper coupons) as an effective means of advertising and attracting customers to purchase products (e.g., goods and services) associated with the businesses. However, the businesses may lack sufficiently sophisticated technology for validating coupons and/or detecting fraudulent coupons.

Conventional technology includes validating the coupons at a Point of Sale (POS) by manually comparing the coupons to a file of fraudulent coupons maintained at the POS counters. Such manual validations of the coupons may be highly error prone. Further, manual validation of the coupons may be labor intensive. In addition, maintaining the file of fraudulent coupons, distributing the file to every branch of the business, frequently updating the list of fraudulent coupons, and training personnel at the POS may be cost intensive. Thus, there is a need for a technology that provides efficient fraudulent coupon detection.

### BRIEF DESCRIPTION OF THE DRAWINGS

Example embodiments are illustrated by way of example and not limitation in the figures of the accompanying drawings, in which:

FIG. 1 illustrates an exemplary paper coupon fraud detection system, according to certain exemplary embodiments of the present invention.

FIG. 2 illustrates a functional block diagram of the coupon fraud detection server, according to certain exemplary embodiments of the present invention.

FIG. 3 is a flow chart that illustrates a process of fraud detection including coupon validation at the POS system, according to certain exemplary embodiments of the present invention.

FIG. 4 is a flow chart that illustrates a process of fraud detection including coupon validation at the coupon fraud detection server, according to certain exemplary embodiments of the present invention.

FIG. 5 illustrates a database building process for paper coupon fraud detection, according to certain exemplary embodiments of the present invention.

FIG. 6 is a flow chart that illustrates a process of building the database for paper coupon fraud detection, according to certain exemplary embodiments of the present invention.

FIG. 7 is a flow chart that illustrates a process of updating a valid coupon database, according to certain exemplary embodiments of the present invention.

FIGS. 8A-8B (collectively ‘FIG. 8’) is a flow chart that illustrates a process of nominating fraudulent coupon candidates, according to certain exemplary embodiments of the present invention.

FIG. 9 is a flow chart that illustrates a process of the paper coupon fraud detection system when the coupon fraud detection server receives a product code, according to certain exemplary embodiments of the present invention.

FIG. 10 is a flow chart that illustrates a process of determining if a coupon code is fraudulent at the coupon fraud detection server, according to certain exemplary embodiments of the present invention.

FIG. 11 is a flow chart that illustrates a process of the coupon fraud detection system when the coupon fraud detection server receives a coupon code, according to the certain exemplary embodiments of the present invention.

FIG. 12 illustrates an example hardware diagram of a general purpose computer 1200, according to certain exemplary embodiments of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the Detailed Description that follows.

### DETAILED DESCRIPTION

Disclosed are a system, a method and an apparatus for paper coupon fraud detection. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

The term “paper coupon” as used herein can generally refer to any appropriate print or paper embodiment of a promotion. The promotion can include, but is not limited to a coupon. Each paper coupon (hereinafter “coupon”) may have an identifier that can be used to uniquely identify the coupon, such as a coupon code. The coupon code can be machine readable. The coupon code can be a universal product code (UPC). In one embodiment, the UPC can include, but is not limited to a bar code. One of ordinary skill can understand and appreciate that the bar code and/or the UPC can be replaced with any other appropriate code or identifier without departing from the broader scope and spirit of the present invention. For example, a European Article Number (EAN) can be used instead of a UPC code or a QR code can be used instead of a bar code.

The coupon may include a UPC bar code along with other information. The other information present on the coupon can include, inter alia, a product description, an offer detail, terms and conditions, expiration date of the coupon, publication date of the coupon, the issuer of the coupon, a category of the coupon, a numerical representation of the UPC coupon bar code, and a list of trigger item codes. In some embodiments, the UPC bar code and/or any other appropriate information on the coupon can be used to uniquely identify the coupon.

A UPC coupon bar code can include, inter alia, a number system character (NSC), a manufacturer's number (hereinafter “manufacturer's code”), a family code, a value code, and a check digit. For example, the number 512345678900 may be an exemplary number representative of an exemplary UPC coupon bar code. In the example, the first digit 5 may represent the NSC, the next 5 digits ‘12345’ may represent the manufacturers code, the next 3 digits ‘678’ may represent the family code, the next two digits ‘90’ may represent the value code that identifies the redemption value of the coupon and the last digit ‘0’ may represent the check digit.

In one example embodiment, the coupon may be made available on any appropriate print media (e.g., newspaper, magazine, etc.). In another example embodiment, the coupon may be made available on a digital media (e.g., web page) in printable format, which a user can download and print. In one example embodiment, the coupon may be may be acquired by a computing device, such as a mobile computing device, by capturing an image of the coupon. Further, the image of the coupon may be presented at a reader device that scans the image and receives the information associated with the coupon. In another example embodiment, the reader device can scan a physical coupon when the physical coupon is presented at the reader device.

The term ‘trigger item code’ as used herein can generally refer to any appropriate code representative of a purchasable product. In one embodiment, the trigger item code can be any appropriate code (e.g., bar code) and/or a numerical representation of the code. Each coupon code may have an associated list of trigger item codes. The trigger item codes may be codes representative of products for which the coupon is applicable. In one embodiment, one coupon may be applicable for one product. In another embodiment, each coupon may be applicable to a number of products. For example, an offer associated with one coupon may be applicable to a number of products. Following the example, a coupon by manufacturer X, may be applicable to products A, B, C, and D of the manufacturer.

The term ‘product code’ as used herein can generally refer to any appropriate computer generated and computer readable code representative of a product. Each product may have an identifier, such as the product code. In an example embodiment, the product code may be located on a packaging of the product or a tag coupled to the product. The product code can be a UPC product bar code and/or a numerical representation of the bar code, in some embodiments. For example, the numerical representation of the UPC product bar code can be a 10 digit number comprising a manufacturer code, a family code and a value code that uniquely identifies the product.

The term ‘fraudulent coupon’ as used herein may generally refer to any appropriate coupon that has been manipulated to change any appropriate attribute of the coupon from the original factory issued format of the coupon. In one embodiment, the attribute of the coupon can be a value attribute and/or a monetary attribute. The value attribute and/or monetary attribute of the coupon can include, inter alia, a bar code, a value code in the bar code, a discount information, a description of the coupon, a numerical representation of the UPC coupon bar code, and a trigger item code. For example, a user may have manipulated a coupon using Photoshop to change the bar code number or to change a value of the coupon from $1 off to Free.

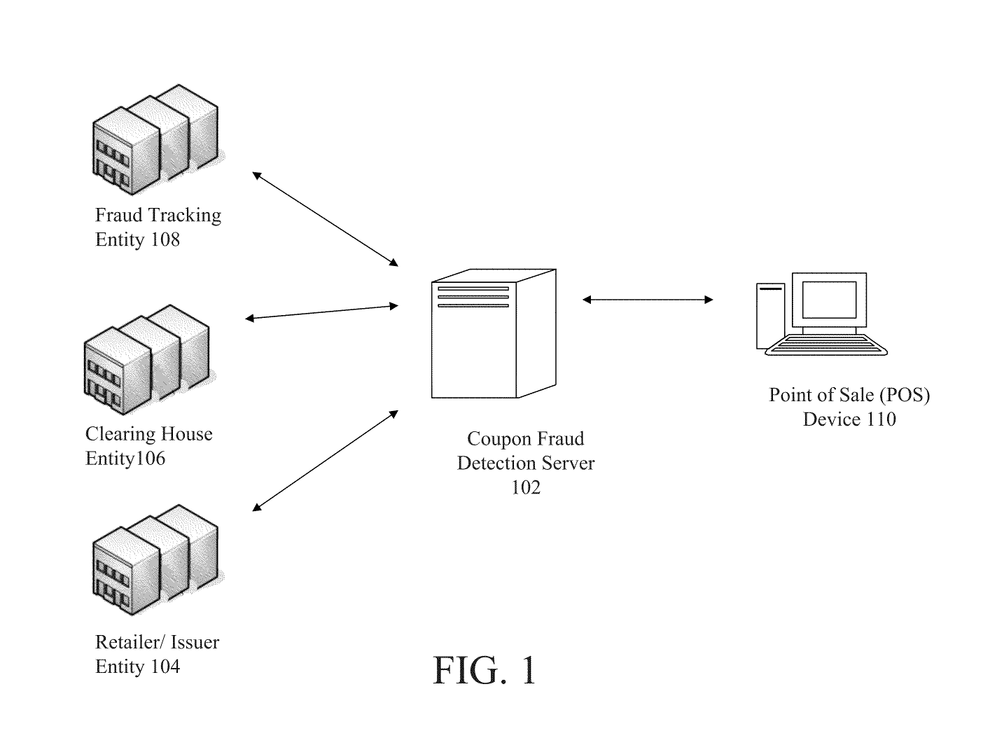

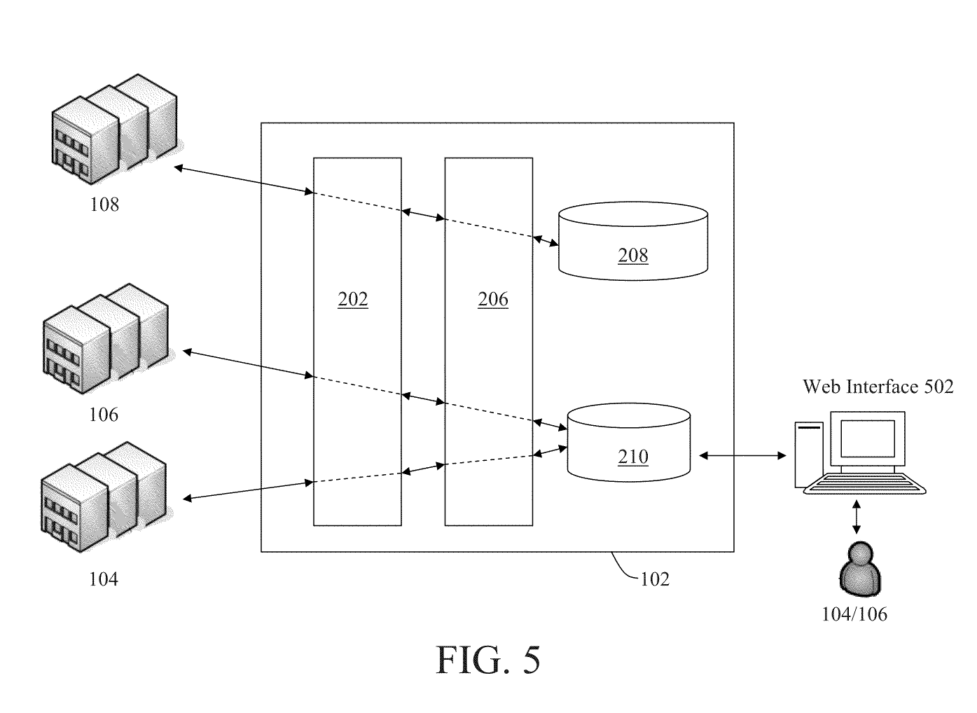

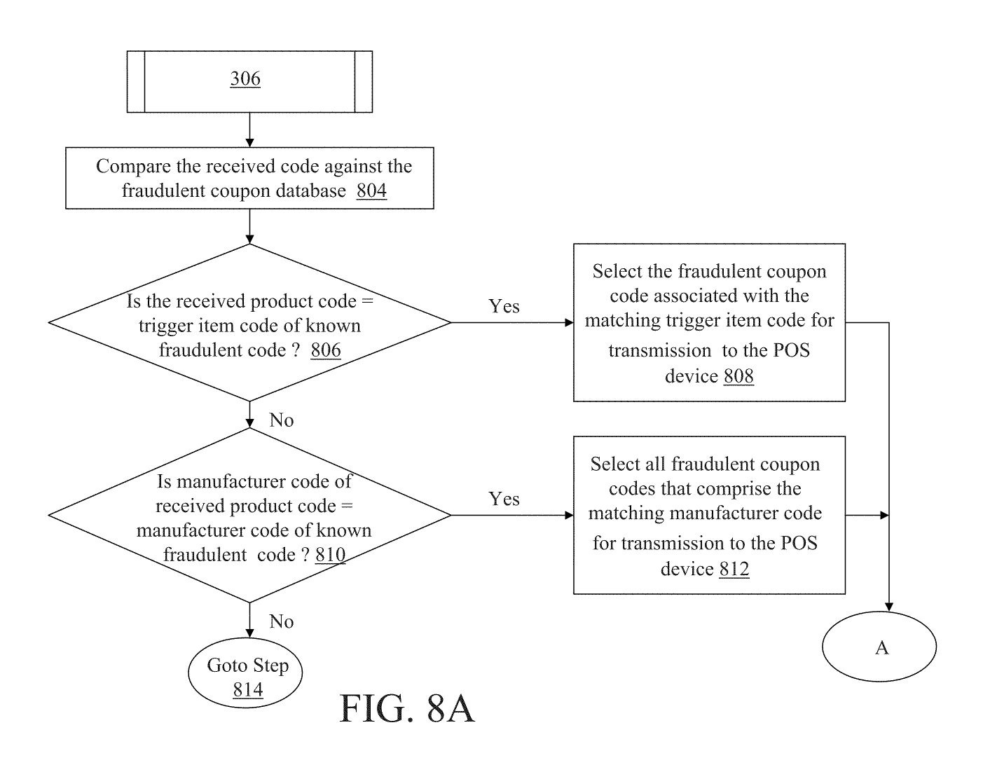

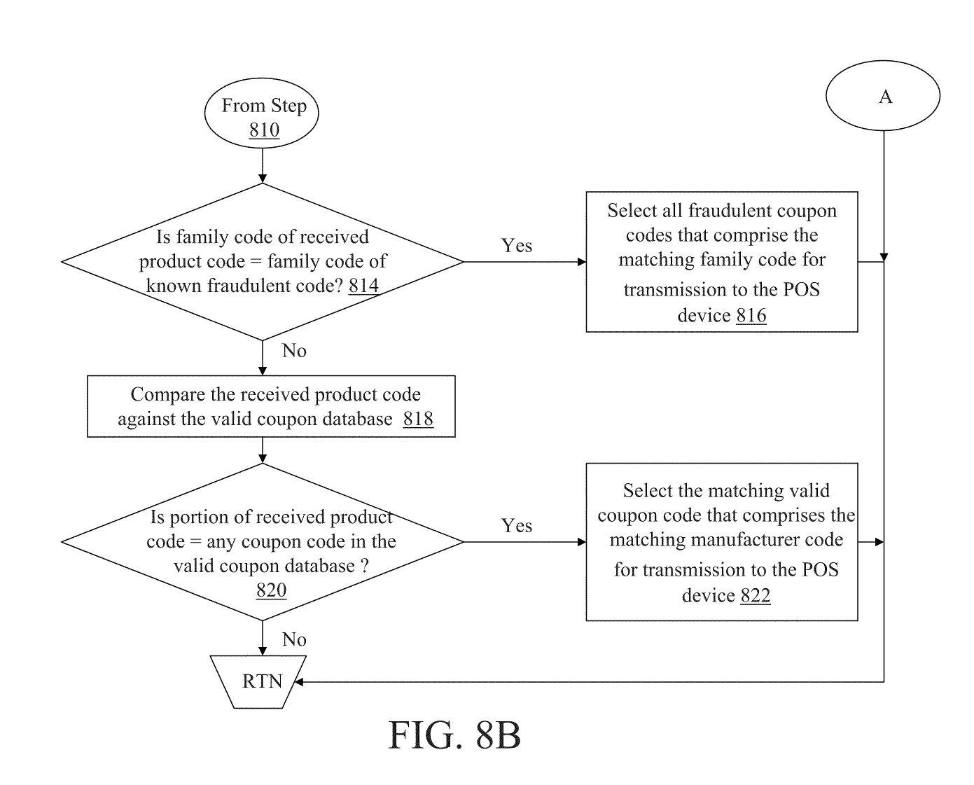

Technology for paper coupon fraud detection will now be described in greater detail with reference to FIGS. 1-11, which describe representative embodiments of the present invention. FIGS. 1, 2, 3 and 4 describe the coupon fraud detection system, as an exemplary embodiment of an operational environment of paper coupon fraud detection. FIGS. 5-7 describe building the database for paper coupon fraud detection using suitable illustrations and flowcharts. Further, FIGS. 8-11 describe the different embodiments of paper coupon fraud detection using suitable illustrations and flowcharts.

The present invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting and among others supported by representations of the present invention.

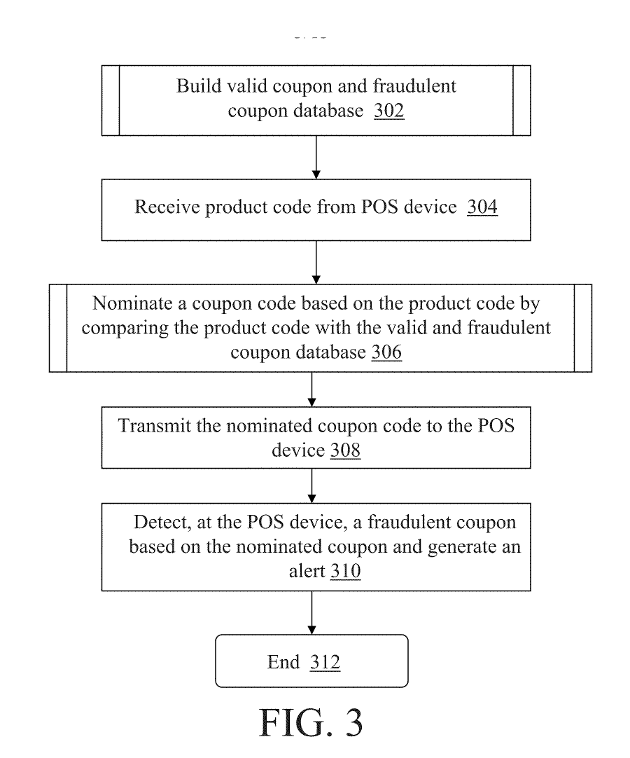

Although specific operations are disclosed in the flowcharts illustrated in FIGS. 3-4, and FIGS. 6-11, such operations are exemplary. That is, embodiments of the present invention are well suited to performing various other operations or variations of the operations recited in the flowcharts. It is appreciated that the operations in the flowcharts illustrated in FIGS. 3-4, and FIGS. 6-11 may be performed in an order different than presented, and that not all of the operations in the flowcharts may be performed.

All, or a portion of, the embodiments described by the flowcharts illustrated in FIGS. 3-4, and FIGS. 6-11 can be implemented using computer-readable and computer-executable instructions which reside, for example, in computer-usable media of a computer system or like device. As described above, certain processes and operations of the present invention are realized, in one embodiment, as a series of instructions (e.g., software programs) that reside within computer readable memory of a computer system and are executed by the processor of the computer system. When executed, the instructions cause the computer system to implement the functionality of the present invention as described below.

In a coupon fraud detection system, first a customer may scan a coupon and/or a product at a Point of sale (POS) device at the merchant/retailer store. As the product and/or coupon is scanned, the POS device may transmit information associated with the coupon and/or the product to a coupon fraud detection server (hereinafter ‘server’). Further, the server processes the received information and returns information regarding the authenticity of the coupon to the POS device in near real-time. The POS device may alert a cashier or an attendant regarding a fraudulent coupon, if information received from the server provides an indication that the coupon used by the customer is fraudulent. In some embodiments, the returned information may include an identifier of the fraudulent coupon, such as a list of UPCs and/or trigger item codes which the POS device may have to further process to determine if a scanned coupon is fraudulent.

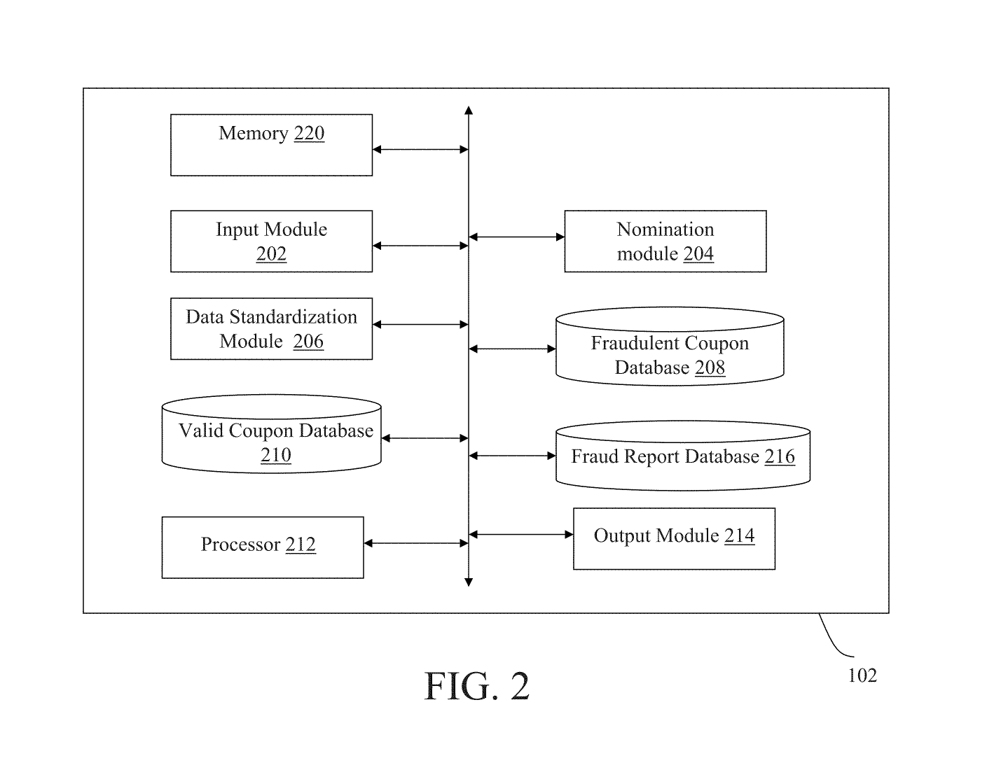

Moving now to discuss the figures further, an exemplary embodiment of the present invention will be described in detail. First, FIG. 1 will be discussed in the context of describing a representative operating environment associated with paper coupon fraud detection according to certain exemplary embodiments of the present invention. FIGS. 2-4 will be discussed, making exemplary reference back to FIG. 1 as may be appropriate or helpful. Further, the remaining FIGS. 5-11 will be discussed, making exemplary reference back to FIGS. 1-4 as may be appropriate or helpful.

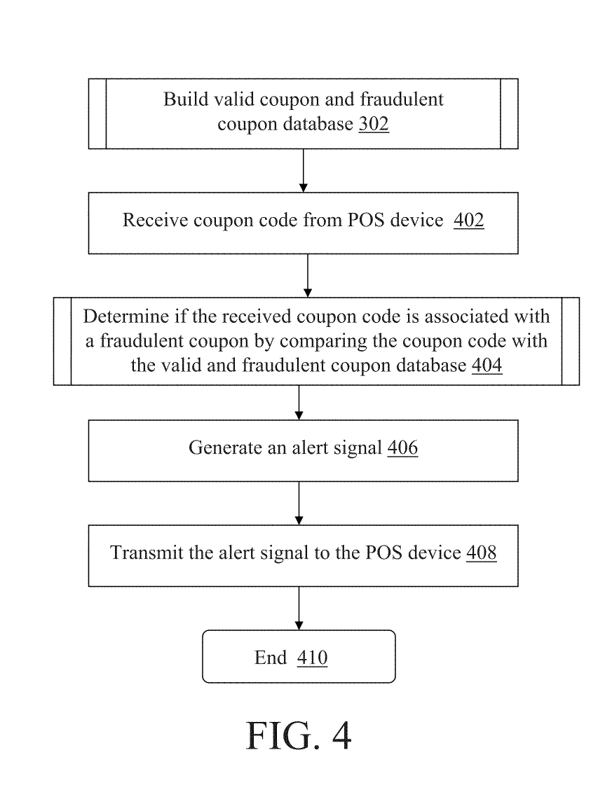

As further discussed below and in accordance with certain embodiments of the present invention, FIG. 1 illustrates an exemplary system that is useful for paper coupon fraud detection; while FIG. 2 illustrates exemplary system elements such as a coupon fraud detection server and FIGS. 3-4 illustrate exemplary flow charts representing operation of the system.

Referring now to FIG. 1, this figure illustrates an exemplary paper coupon fraud detection system, according to certain exemplary embodiments of the present invention. In particular, FIG. 1 illustrates a fraud tracking entity 108, a clearing house 106, a retailer/issuer entity 104, a coupon fraud detection server 102 (referred to as ‘server’), and a POS device 110.

In an exemplary embodiment, the coupon fraud detection system can include a POS device 110. The POS device 110 can include a cash register handled by an attendant or a self-checkout register. The POS device 110 can be configured to scan any appropriate coupon code and/or product code. For example, the POS device 110 can read a UPC product bar code and/or a UPC coupon bar code. In some embodiments, the POS device 110 can be configured to scan and read other identifiers (e.g., codes) representative of the product and/or coupon. Once the codes are scanned, the POS device 110 can be configured to transmit the scanned information to a server 102. In addition to transmitting information, the POS device 110 may be configured to receive information from the server 102.

The information received from the server 102 can include, inter alia, an identifier of a fraudulent and/or valid coupon, such as a list of UPCs or item trigger codes. Further, the information received from the server 102 can include information regarding the authenticity of a coupon, such as an alert signal or message generated at the server 102. Responsive to receiving information from the server 102, the POS device 110 can be configured to process the information received from the server 102. In an additional embodiment, the POS device 110 may be configured to generate alert signals and/or notify a cashier or an attendant of a fraudulent coupon. In a further embodiment, the POS device 110 may include a display device (not shown in the Figure), that can display an alert message.

In one embodiment, the POS device 110 may include a light weight software message broker (hereinafter ‘message broker,’ not shown in Figure). The message broker may be configured to communicate messages between the POS device 110 and the server 102 over the network. The message broker may be implemented within a base code of POS software which runs on the POS device 110. The message broker may be configured to collect product codes and/or coupon codes as they are scanned at the POS device 110 and transmit the collected codes to the server 102 in near real-time. Further, the message broker may be configured to receive information from the server 102 and process the information, if necessary. For more information on the message broker, see, for example, “Message Broker for Redemption of Digital Incentives,” as disclosed in U.S. patent application Ser. No. 12/783,762, filed May 20, 2010, now published as U.S. Publication Number 2010/0299198, and “Digital Incentives Issuance, Redemption, and Reimbursement,” U.S. patent application Ser. No. 12/783,666, filed May 20, 2010, now published as U.S. Publication Number 2010/0299266, the entire contents of which are hereby incorporated herein by reference.

In addition to the message broker, the POS device 110 may have network and peer-peer communication capabilities. The POS device 102 may be communicably coupled to the server 102 via a network (not shown in Figure). The network may be a wireless network and/or a wired network. Further, the POS device 110 may be at a remote location from the server 102. For example, the POS device 110 may be located at the retailer or merchant store, while the server 102 may be located in a cloud network which is at a remote location from the POS device 110.

In an exemplary embodiment, the coupon fraud detection system includes a server 102. The server 102 may be communicably coupled to the fraud tracking entity 108, the clearing house 106, the retailer/issuer entity 104, and/or the POS device 110 over a network (not shown in FIG. 1). The server 102 can receive information from and transmit information to the fraud tracking entity 108, the clearing house 106, the retailer/issuer entity 104, and/or the POS device 110 via the network.

In one embodiment, the server 102 can be a cloud based server. The server 102 can receive information from the POS device 110. The information received from the POS device 110 can include, inter alia, a coupon code of a coupon scanned at the POS device 110 and/or a product code of a product scanned at the POS device 110. In addition, the server 102 can receive information from external entities, such as the fraud tracking entity 108, the clearing house 106, and the retailer/issuer entity 104. The information received from the external entities can include information regarding valid or fraudulent coupon that are known in the industry. Responsive to receiving information from the POS device 110 and the external sources, the server 102 can be configured to process the received information and generate resulting information that is transmitted back to the POS device 110. The resulting information transmitted back to the POS device 110 can include, inter alia, an identifier of a fraudulent or valid coupon (e.g., UPCs or trigger item codes) and/or alert signal/message. The server 102 is described in greater detail below, in accordance with FIG. 2.

Now refer to FIG. 1 and FIG. 2. FIG. 2 illustrates a functional block diagram of the coupon fraud detection server, according to certain exemplary embodiments of the present invention. In particular, FIG. 2 illustrates an input module 202, a nomination module 204, a standardization module 206, a fraudulent coupon database 208, a valid coupon database 210, a fraud report database 216, a processor 212 and an output module 214.

In one embodiment, the processor 212 can be a multi-core processor. In another embodiment, the processor 212 can be a combination of multiple single core processors. In one embodiment, the server 102 can include a memory 220 coupled to the processor 212. The memory 220 can be non-transitory storage medium, in one embodiment. The memory 220 can include instructions. The processor 212 can execute the instructions to perform operations of the server 102. In other words, operations associated with the different modules of the server 102 can be executed using the processor 212. In one embodiment, the server 102 can include one or more data processing devices such as computers mounted on a rack.

In an exemplary embodiment, the server 102 can include a web portal (e.g., web interface 502, shown in FIG. 5) and a user can access the server 102 through the web portal (hereinafter ‘web interface). The users authenticated to access the server 102 through the web portal may include manufacturers, retailers, entities that issue the coupons, and/or clearing houses.

The users can interact with the server using the web interface. In one embodiment, the server 102 can be configured to display information available in the valid coupon database 210 and the fraudulent coupon database 208 through the web interface. The users can browse the list of valid and/or fraudulent coupons and edit the database to add new coupon information, delete existing coupon information and modify coupon information. The said edit operations are for illustrative purposes and one of ordinary skill in the art can understand and appreciate that other appropriate edit operations may be available to a user without departing from the broader scope and sprit of the present invention. In one embodiment, the user can flag a valid coupon through the web interface. A flagged valid coupon may be a valid coupon that is not honored by the retailer and/or manufacturer. When a retailer flags a coupon, the flagging may be restricted to the retailer, but when a manufacturer or coupon issuer flags a coupon the information is updated globally and can be seen by all users that have access to the database (208 and/or 210) of the server 102. The user may flag a coupon for various reasons, such as the coupon may have a high value and the user (e.g., retailer) may not want to accept high value coupons. The coupon may be flagged because the coupon may be a free coupon and the retailer may not accept free coupons at the store. In another exemplary embodiment, a user may flag a valid coupon because the coupon may be offering promotions to competitors of the users private label brands.

In the exemplary embodiment, the server 102 can include an input module 202. In an example embodiment, the input module 202 can include a web interface module (not shown in Figure) that is associated with providing a web portal for users to access the server 102.

The input module 202 of the server 102 may be configured to receive information from the fraud tracking entity 108, the clearing house 106, the retailer/issuer entity 104, and/or the POS device 110 via a network. In one embodiment, the information received from the fraud tracking entity 108 may be used to build the fraudulent coupon database 208 of the server 102. Further, the information received from the clearing house 106, and/or the retailer/issuer entity 104 may be used to build the valid coupon database 210. In one embodiment, the input module 202 may forward the information from the fraud tracking entity 108, the clearing house 106, and/or the retailer/issuer entity 104 to the data standardization module 206. In another embodiment, the input module 202 may forward the information received from the POS device 110 to the nomination module 204.

The data standardization module 206 may be configured build the valid coupon database 210 and the fraudulent coupon database 208 by extracting, transforming, and loading (ETL) the information received from the external entities 104/106/108 into the respective databases 208 and 210 of the server 102. ETL may refer to a process in a database usage that comprises extracting data from a source, transforming the extracted data to fit operational needs of the server 102, and loading the transformed data to the respective database (208 and/or 210) of the server 102. Building the database 208 and 210 of the server 102 is described in greater detail below, in accordance with FIGS. 5-7.

Now referring to FIG. 1 and FIGS. 5-7, FIG. 5 illustrates a database building process for fraud detection, according to certain exemplary embodiments of the present invention. In particular, FIG. 5 illustrates the coupon fraud tracking entity 108, the clearing house 106, the retailer/issuer entity 104, the POS device 110, the server 102, user 104/106 and, the web interface 502 accessible by a computing device.

In one embodiment, the server 102 may gather data about both valid coupons and fraudulent coupons from various data sources such as the coupon fraud tracking entity 108, the clearing house entity 106, and/or the retailer/issuer entity 104.

In one embodiment, the data about the fraudulent coupon may include UPC coupon code of fraudulent coupons known in the industry. In another embodiment, the data about the fraudulent coupons may both the UPC coupon code of the fraudulent coupon and trigger item codes associated with each UPC coupon code of the fraudulent coupon. Both the UPC coupon code and the trigger item code can be used as fraudulent coupon identifiers.

In one embodiment, the data of the valid coupons can include the UPC coupon code of the valid coupon known in the industry and/or trigger item codes associated with each UPC coupon code of the valid coupon which can used as valid coupon identifiers.

The information gathered by the server 102 about the coupons can be used to populate either the valid coupon database 210 or the fraudulent coupon database 208. In one embodiment populating the database 208 and/or 210 may include standardizing the received data. The information received from the various sources may be standardized by the data standardization module 206. Once the data is standardized, the data standardization module 206 may load the standardized data to the valid coupon database 210 or the fraudulent coupon database 208 to build the database.

Once the data is loaded, a user (e.g., retailer/issuer entity 104 and/or the clearing house entity 106) may be provided with a list of valid coupons via the web interface 502. In one embodiment, the user 104/106 can browse the list of valid coupons through a web interface 502. The user may decide to flag a coupon even though the coupon is valid for various reasons described above in FIG. 2.

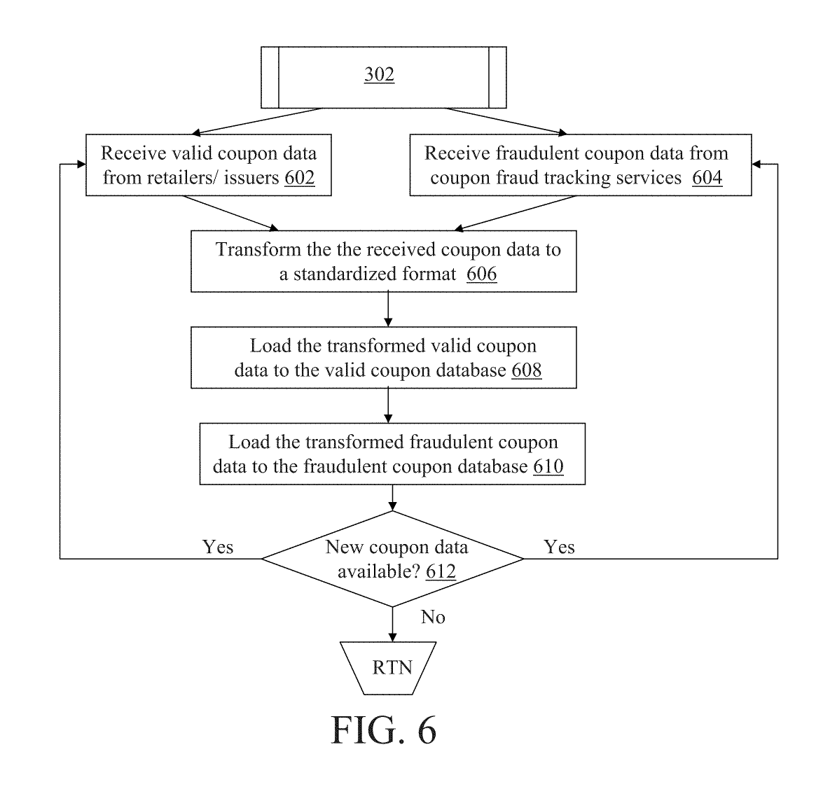

Now turning to FIG. 6, FIG. 6 is a flow chart that illustrates a process of building the database for fraud detection, according to certain exemplary embodiments of the present invention. In operation 602, the input module 202 of the server 102 may receive files that include valid coupon data known in the industry. The valid coupon data may be received from retailers, entities that issue the coupon 104, and/or clearing house entities 106. Similarly, in operation 604 the input module 202 may receive files including the fraudulent coupons from the coupon fraud tracking entity 108.

Once the files are received by the input module 202, the input module 202 may forward the received files to a data standardization module 206. Upon receiving the files, the data standardization module 206 may run the files through the ETL process to format (e.g., standardize) the data and address quality issues. The ETL process is well known in the art and therefore not described herein in further detail. The received files can include data organized different formats based on the source of the data. In operation 606, the data standardization module 206 may transform the data in the files to a standard format. In other words, the data standardization module may transform the data in the files to a format fit for the operational needs of the server 102. In operation 608, the standardized valid coupon data is loaded into the valid coupon database 210 and in operation 610, the standardized fraudulent coupon data is loaded into the fraudulent coupon database 208.

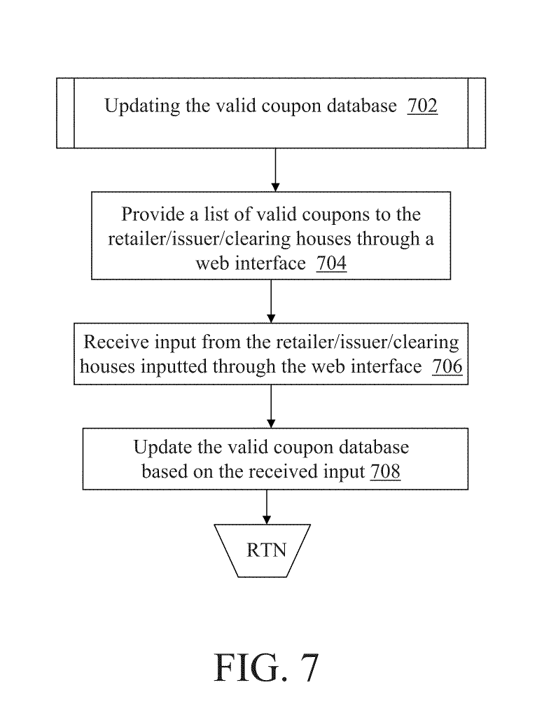

Once, the valid coupon database 210 and the fraudulent coupon database 208 are populated, in operation 612, the server 102 checks if there are any new coupon data available. In one embodiment, the server 102 may be configured to proactively search the various sources for new coupon data (valid and/or fraudulent) at predetermined time intervals. The server 102 may be scheduled to search for new coupon data at regular time intervals, for example once every day, once every week, twice every month, every other minute, second and so on. In another embodiment, the server 102 may be configured to search for new coupon data continuously in time as opposed to regular time intervals. In yet another embodiment, the server 102 may be configured to receive new data from the various sources when a new coupon data is available or at regular time intervals. If new coupon data is available, then the input module receives the new data and the process repeats from operation 606 to 612. The process ends in operation 614 if no new coupon data is available. In other words, as and when new coupon data is available, the process starts again at operation 602 or operation 604 based on the data and continues through operation 612. Once the valid coupon database 210 is built, a user may access the list of valid coupons through a web interface 502 as described in greater detail in accordance with FIG. 7.

FIG. 7 is a flow chart that illustrates a process of updating a valid coupon database, according to certain exemplary embodiments of the present invention. In operation 704, the server 102 may present a list of valid coupons in the valid coupon database 210 to a user 104/106 through a web interface 502. In one embodiment, the user 104/106 may access the valid coupon database 210 while the database is being built. In another embodiment, the user 104/106 can access the valid coupon database 210 after the database 210 is built. In addition to accessing, the user 104/106 can browse the list of valid coupons and can edit the list through the web interface 502 as described above in accordance with FIG. 2.

In operation 706, the input module 202 may receive an input from the user 104/106 that the user may enter via the web interface 502. The input may be associated with editing the list of valid coupons and/or flagging one or more valid coupons in the database 210. For example, when a manufacturer is informed of a fraudulent coupon that is manipulated to appear like a valid coupon, then the manufacturer may access the list via the web interface 502 and flag the corresponding valid coupon.

In operation 708, the server may update the valid coupon database 210 based on the input from the user 104/106. Updating may include adding a new coupon data or editing and existing coupon data. The process ends at operation 710.

Referring back to FIG. 2, the server 102 includes a valid coupon database 210 and a fraudulent coupon database 208. As described in accordance with FIGS. 5-7, the valid coupon database 210 may be populated with the UPC coupon codes of valid coupons known in the industry and/or trigger item codes associated with the UPC coupon codes of valid coupons. Further, the fraudulent coupon database 208 may be populated with the UPC coupon codes of fraudulent coupons known in the industry and/or trigger item codes associated with the UPC coupon codes of fraudulent coupons. In an exemplary embodiment, the database 208 and 210 may be structured to cater to an optimized search operation. In one embodiment, the databases 208 and 210 may be located outside the server 102, wherein the server 102 may be coupled to the databases 208 and 210.

In an exemplary embodiment, the server 102 includes a nomination module 204. The nomination module 204 may be configured to receive information from the POS device 110 via the input module 202.

In one embodiment, the information from the POS device 110 may include a product code of a product scanned at the POS device 110. Once the product code is received, the nomination module 204 may be configured to elect (retrieve or nominate) a fraudulent coupon code and/or a valid coupon code based on the product code. Further, the nominated coupon code (fraudulent and/or valid) may be transmitted to the POS device 110 through the output module 214.

In another embodiment, the nomination module 204 may be configured to receive a coupon code from the POS device 110 via the input module 202. The coupon code may be associated with a coupon scanned at the POS device 110. Once the coupon code is received, the nomination module 204 may be configured to determine if the received coupon code is a valid coupon code or a fraudulent coupon code. If the nomination module 204 determines that the coupon code is a fraudulent coupon code, then the nomination module 204 may record the fraudulent coupon code in fraud report database 216 which maintains a log of fraudulent coupon activities. Once the fraud report database 216 is updated, the nomination module 204 generates an alert message which may be transmitted to the POS device 110 through the output module 214.

The output module 214 may be configured to communicate with the POS system 110, the retailer/issuer entity 104, the clearing house entity 106 and/or the coupon fraud tracking entity 108. Further, the server 102 may include a transceiver and/or communication ports adapted to connect to a network (not shown in Figure) or another computing device. The coupon fraud detection mechanism of the server 102 is described in greater detail in accordance with FIGS. 3 and 4.

Turning to FIG. 3, FIG. 3 is a flow chart that illustrates a process of fraud detection at the POS system, according to certain exemplary embodiments of the present invention. In operation 302, the server 102 is configured to build the valid coupon database 210 and the fraudulent coupon database 208 which is described above in accordance with FIGS. 5-7. Once the databases 208 and 210 are built, as described above the databases may be updated at regular intervals or continuously in time.

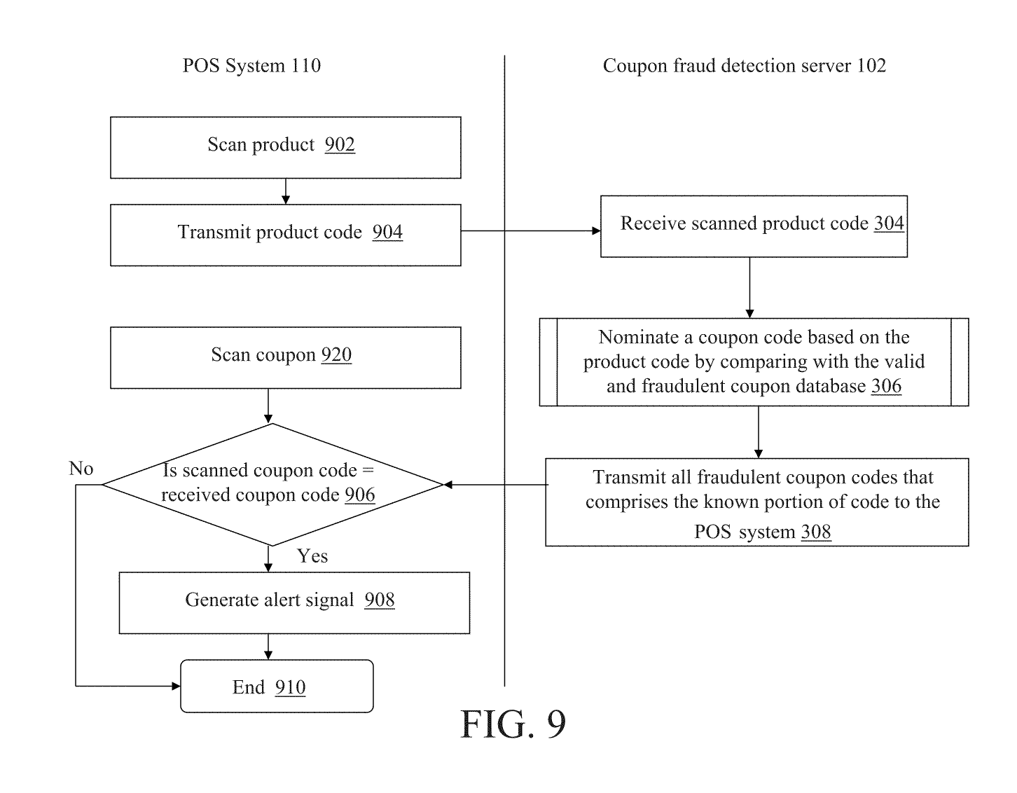

In operation 304, the server 102 receives a product code from the POS device 110. The product code may be associated with a product scanned at the POS device 110. Once the product code is received, the server 102 may parse the product code to determine a manufacturer code, a family code, and/or a value code embedded in the product code. Then, in operation 306, the server 102 can be configured to nominate a valid coupon code and/or a fraudulent coupon code based on the product code. Nomination of the valid coupon code and/or a fraudulent coupon code is described in greater detail in accordance with FIGS. 8-9.

Turning to FIGS. 8A and 8B, FIGS. 8A-8B (collectively ‘FIG. 8’) are flow charts that illustrate a process of nominating fraudulent coupon candidates, according to certain exemplary embodiments of the present invention. Once the product code is received, in operation 804, the server 102 compares the product code against data in the fraudulent coupon database 208. The fraudulent coupon database 208 may include a list fraudulent coupon identifiers, such as a list of UPC coupon codes of known fraudulent coupons and/or list of trigger item codes associated with each UPC coupon code. If the fraudulent coupon database 208 includes the trigger item codes, then in operation 806, the nomination module 204 compares the received product code with the list of trigger item codes to find a match. If a match is found, then in operation 808, the nominating module 204 selects the fraudulent coupon code associated with the matching trigger item code for transmission to the POS device 110. If the product code does not match with a trigger item code in the fraudulent coupon database 208, then the nomination module proceeds from operation 806 to operation 810. If the fraudulent coupon database 208 does not include the trigger item codes, then then nomination module may omit operation 806 and directly proceed from operation 804 to operation 810.

In operation 810, the nomination module 204 compares a manufacturer code of the product code with the manufacturer code of all the fraudulent coupon codes in the fraudulent coupon database 208 to find a match. If the manufacturer code of the product code matches with the manufacturer code of a fraudulent coupon code, then in operation 812, the nomination module 204 selects the fraudulent coupon code that comprises the matching manufacturer code for transmission to the POS device 110. In some embodiments, the manufacturer code of the product code may match with the manufacturer code of more than one fraudulent coupon codes. If the manufacturer code of the product code does not match with the manufacturer code of list of fraudulent coupon codes in the database, then the nomination module 204 proceeds from operation 810 to 814.

In operation 814, the nomination module 204 compares a family code of the product code with the family code of all the fraudulent coupon codes in the fraudulent coupon database 208 to find a match. If the family code of the product code matches with the family code of a fraudulent coupon code, then in operation 816, the nomination module 204 selects the fraudulent coupon code that comprises the matching family code for transmission to the POS device 110. In some embodiments, the family code of the product code may match with the family code of more than one fraudulent coupon code. If the family code of the product code does not match with the family code of list of fraudulent coupon codes in the database, then the nomination module 204 proceeds from operation 814 to 818.

In operation 818, the received product code is compared against data in the valid coupon database 210. The valid coupon database 210 may include valid coupon identifiers, such as a list of UPC coupon codes of known valid coupons and/or list of trigger item codes associated with each UPC coupon code of the valid coupon. If the valid coupon database 210 includes the trigger item codes, then the nomination module 204 compares the received product code with the list of trigger item codes in the valid coupon database 210 to find a match. If a match is found, then in operation 808, the nominating module 204 selects the valid coupon code associated with the matching trigger item code for transmission to the POS device 110. If the product code does not match with a trigger item code in the valid coupon database 210, then the nomination module proceeds to operation 820 from operation 818.

In operation 820, the nomination module 204 compares a portion of the product code with a corresponding portion of all the valid coupon identifiers in the valid coupon database 210 to find a match. If the portion of the product code matches with the corresponding portion of a valid coupon code, then in operation 822, the nomination module 204 may selects the valid coupon code that comprises the matching portion for transmission to the POS device 110. In some embodiments, the portion of the product code may match with the corresponding portion of more than one valid coupon code.

The comparison of the portion of the product code with a corresponding portion of the valid coupon code in the database 210 may be similar to the operations 810 and 814 where first, the manufacturer codes are compared followed by comparison of the family codes except that in operation 820, the comparison may be done against valid coupon identifiers. Further, if a match is found between the portion of the product code and the valid coupon code, the nomination module 204 may perform an additional operation (not shown in Figure) of determining if the matching valid coupon codes are flagged and selecting the flagged valid coupon codes for transmission to the POS device 110 along with the matching valid coupon codes.

If the portion of the product code does not match with the portion of list of valid coupon codes in the database 210, then the nomination module 204 returns to operation 308 of FIG. 3.

Turning back to FIG. 3, in operation 308, the nominated valid and/or fraudulent coupon codes (e.g., valid coupon codes and/or fraudulent coupon codes selected for transmission in operation 808, 812, 816, or 822) are transmitted from the server 102 to the POS device 110. Once the POS device 110 receives the nominated coupon codes, in operation 310, the POS device 110 can store the nominated coupon codes in a buffer. The buffer may be refreshed periodically. Further, in operation 310, the POS device 110 detects a fraudulent coupon based on the nominated coupon code received from the server 102. In addition, in operation 310, if a fraudulent coupon is detected, the POS device 110 may generate an alert and necessary actions may be taken at the POS device 110. The process ends at operation 312. The operation of the coupon fraud detection system of FIG. 3 is described in further detail in accordance with FIG. 9.

Turning to FIG. 9, FIG. 9 is a flow chart that illustrates a process of the coupon fraud detection system when the coupon fraud detection server receives a product code, according to certain exemplary embodiments of the present invention.

In operation 902, a customer and/or a cashier may scan a product at the POS device 110. Responsive to scanning the product, the POS device 110 may transmit a product code associated with the scanned product to the server 102, in operation 904.

In one embodiment, the POS device 110 may transmit a product code to the server 102 responsive to scanning the product. In another embodiment, the POS device 110 may transmit a product code to the server 102 after all the products in a customer purchase basket (or cart) have been scanned. In another embodiment, the POS device 110 may transmit a product code to the server 102 responsive to scanning a coupon code. In certain embodiments, the POS device 110 may transmit a product code to the server 102 responsive to scanning a coupon code at the POS device 110 after all the products in a customer basket are scanned. In some embodiments, if there are a number of coupon codes that are being scanned at the POS device 110, then the POS device 110 may transmit a product code to the server 102 responsive to scanning the first coupon code of the number of coupon codes. In yet another embodiment, the POS device 110 may transmit a product code to the server 102 responsive to scanning a product and a coupon.

In operation 304, the server 102 receives the product code from the POS device 110. Once the product code is received, in operation 306, the server 102 nominates a fraudulent coupon code based on the product code by comparing the product code against the identifiers (e.g., UPCs and/or trigger item codes) of plurality of fraudulent coupons in the fraudulent coupon database 208. In another embodiment, in operation 306, the server 102 may nominate a valid coupon code based on the product code by comparing the product code against a valid coupon database 210 as described in FIG. 8. Responsive to nominating the coupon code (valid and/or fraudulent), in operation 308 the server 102 transmits the coupon code to the POS device 110.

In one embodiment, responsive to finding a match between a product code and an identifier of the fraudulent coupon, the server 102 can obtain information about the fraudulent information. Further, the server 102 can process the information, to sort the information of the fraudulent coupon (e.g., when there are more than one matching fraudulent coupons resulting from the comparison with the product code) to list the most relevant fraudulent coupon based on the product code. For example, the UPCs of all the fraudulent coupons that have features (e.g., manufacture code, family code, trigger item code, etc.) that match with the product code may be sorted to list UPC of the most relevant fraudulent coupons, or the UPC of fraudulent coupon codes that are most relevant for a season (e.g., Christmas season), etc. Once the information has been sorted, the server 102 may transmit the sorted information to the POS device 110. In one embodiment, the server 102 may transmit the information of the fraudulent coupon as and when it finds a match during the comparison process. In another embodiment, the server 102 may wait for the comparison process to be completed, aggregate all information of all the matching fraudulent coupons, and process the information prior to transmitting the information to the POS device 110.

In operation 906, the POS system 110 may receive the nominated coupon code and store the nominated coupon code in a memory of the POS device 110. In operation 920, the customer and/or the cashier may scan a coupon at the POS device 110 to redeem an offer associated with the product. Upon scanning the coupon, the POS device 110 retrieves the coupon code. Further, in operation 906, the POS device 110 compares the coupon code of the scanned coupon with the nominated coupon code stored in the memory of the POS device 110. If the coupon code of the scanned coupon matches a nominated fraudulent coupon, then the POS device 110 proceeds to operation 908.

In operation 908, the POS device 110 generates an alert signal. In some embodiments, the POS device may generate an alert message. Further, the alert message may be displayed on a display device associated with the POS device 110. The alert message may prompt the cashier or an attendant to take necessary action. In addition, the alert signal/message may be transmitted to a social network platform such as Facebook, Google plus, or Twitter. In another embodiment, the alert message may be transmitted to a store manager, a store security officer, a retailer entity, etc., via email, SMS, MMS, phone call, or other alert mechanisms. In some embodiments, the alert signal may trigger a visual alert at the POS device. In yet another embodiment, the alert signal may trigger an auditory or tactile alert system. In addition, the POS device may send an alert to a coupon fraud tracking agency and/or a policing agency. The process ends at operation 910.

In one embodiment, responsive to detecting the fraudulent coupon based on comparison with a nominated fraudulent coupon, the POS device 110 can send information about the detected fraudulent coupon back to the server 102. The information about the detected fraudulent coupon can include the UPC of the detected fraudulent coupon, the location of the POS device where the fraudulent coupon is detected, and/or an item associated with the detected fraudulent coupon. One of ordinary skill in the art can understand and appreciate that the information about the detected fraudulent coupon could include any other appropriate information as well, and is not limited to the information listed above, without departing from the broader spirit and scope of the present invention. Once, the server 102 receives the information about the detected fraudulent coupon, the server 102 may store the information in a fraud report database 216. Further, the server 102 can be configured to process the information an generate analytics report, such as a report that classifies the usage of a fraudulent coupon based on geographical location. For example, the report can illustrate that a specific fraudulent coupon has been spotted or gets used more frequently at location A as compared to location B. Further, the server can process the information in the fraud report database 216 to generate comparison charts illustrating a list of most frequently used fraudulent coupons. The examples listed above are merely for illustrative purposes and the analytics operation of the present invention should not be considered limited to the listed examples. One of ordinary skill in the art can understand and appreciate that the server 102 can perform numerous other analytics operations without departing from the broader spirit and scope of the present invention. Once the analytics reports are generated, external entities/users 104/106/108 can access the report through the web interface 502. In another embodiment, the external entities can request for customized analytics reports.

In another embodiment, the server 102 may proactively communicate with the POS device 110 to provide information regarding relevant fraudulent or valid coupons, regardless of whether the server 102 receives or does not receive the product code. For example, prior to Thanksgiving season, the server 102 may transmit to the POS device 110, information regarding fraudulent coupons that the POS device 110 could potentially come across during thanksgiving sale. The server 102 may have a record of all the POS device 102 stored in a database of the server 102. In another embodiment, a retailer/issues may register with the server 102 and provide information of all the POS devices associated with the retailer/issuer 104.

Turning now to FIG. 4, FIG. 4 is a flow chart that illustrates a process of fraud detection at the fraud detection server, according to certain exemplary embodiments of the present invention. In operation 302, the server 102 is configured to build the valid coupon database 210 and the fraudulent coupon database 208 which is described above in accordance with FIGS. 5-7. Once the databases 208 and 210 are built, as described above the databases may be updated at regular intervals or continuously in time.

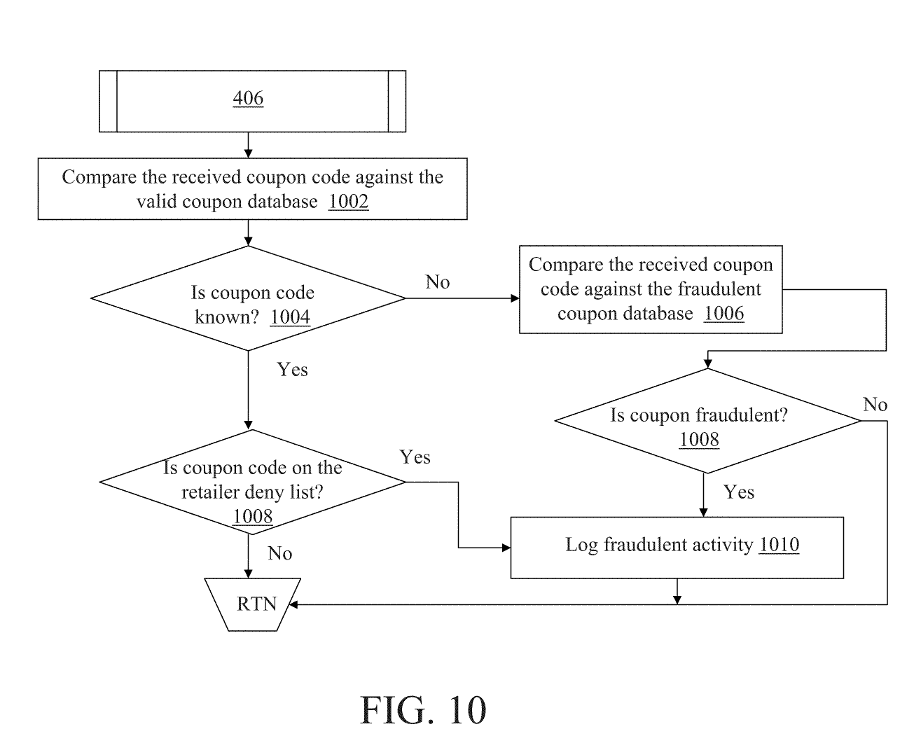

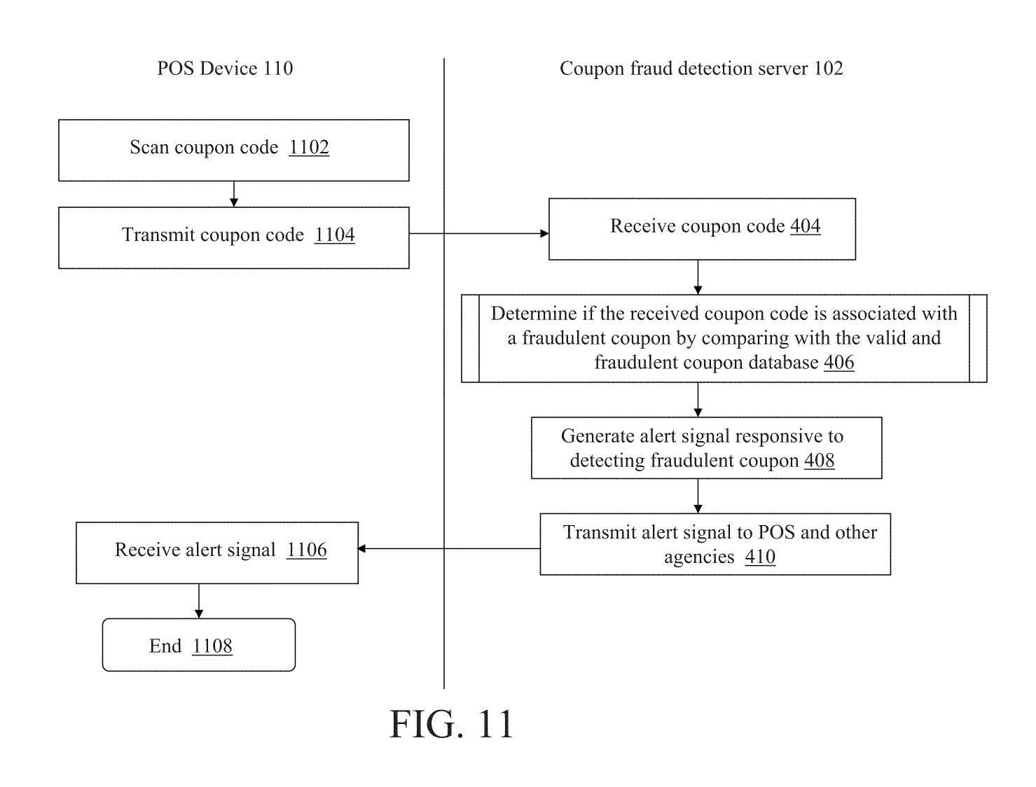

In operation 402, the server 102 receives a coupon code from the POS device 110. The coupon code may be associated with a coupon scanned at the POS device 110. Once the coupon code is received, in operation 406, the server 102 may determine if the received coupon code is valid or fraudulent. The processes of determining the validity of the received coupon code is described in greater detail in accordance with FIGS. 10-11.

Turning to FIG. 10, FIG. 10 is a flow chart that illustrates a process of determining if a coupon code is fraudulent, according to certain exemplary embodiments of the present invention. Responsive to receiving the coupon code, in operation 1002, the server 102 compares the received coupon code against the data stored in the valid coupon database 210 to find a match. In operation 1004, the nomination module 204 checks if the received coupon code matches with a valid coupon identifier (e.g., valid coupon codes) in valid coupon database 210. If the received coupon code matches with a valid coupon code, then the nomination module 204 proceeds to operation 1008. In operation 1008, the nomination server 204 determines if the received coupon code is on a retailer deny list. In other words, if the received coupon code is a valid coupon code, the nomination server further checks to determine if the received coupon code matches a coupon code that is flagged by either the retailer or the manufacturer. If the received coupon code matches a flagged valid coupon code, then the nomination server 204 proceeds to operation 1010. In operation 1010, the received coupon code is logged into a fraud report database 216.

Referring back to operation 1004, if the received coupon code does not match with a valid coupon code, then the nomination module 204 proceeds to operation 1006. In operation 1006, the server 102 compares the received coupon code against the data of a fraudulent coupon database. In operation 1008, the nomination module 204 compares the received coupon code with a number of fraudulent coupon identifiers to find a match. If the received coupon code matches a fraudulent coupon identifier, then the nomination module 204 may determine that the received coupon code is fraudulent. Responsive to determining that the received coupon code is fraudulent, the nomination module 204 records the corresponding fraudulent activity in the fraud report database 216. Once the fraud report database 216 has been updated, the nomination module 204 returns to operation 406 of the server 102. Further, referring back to operation 1008, if the received coupon code does not match with any identifier in the list of fraudulent coupon identifiers, then the nomination module returns to operation 406 of the server 102.

Referring back to FIG. 4, in operation 406, the server 102 may generate an alert signal. In other words, when the server determines that the received coupon code is fraudulent, the server 102 may generate an alert signal/message. In another embodiment, when the server determines that the received coupon code does not match a valid coupon code and a fraudulent coupon code, then the server 102 may generate an alert signal/message, wherein the alert signal/message informs the POS device 110 that the received coupon code is not fraudulent, but neither is it valid. Further, the alert signal/message may instruct an attendant or cashier to validate the coupon manually even if it is not fraudulent.

In operation 408, the server 102 may transmit the alert signal/message to the POS device 110. Responsive to receiving the alert signal/message, the POS device 110 may display the alert message on a display device. Further, the alert signal/message may trigger a visual alert (e.g., glowing key on a keyboard, glowing button, etc.), an auditory alert, and/or a tactile alert. In operation 408, additionally the server 102 may transmit the alert signal/message to a fraud tracking entity and/or policing agency. Further, the server 102 may transmit the alert signal to a store personnel or a security via email, SMS, MMS and the server 102 may update a social network platform such as Facebook, Twitter and/or Google plus. Responsive to transmitting the alert message, the process of the server 102 ends at operation 410.

Referring to FIG. 11, FIG. 11 is a flow chart that illustrates a process of the coupon fraud detection system when the coupon fraud detection server receives a coupon code, according to the certain exemplary embodiments of the present invention. In operation 1102, the POS device 110 may receive a coupon code. The coupon code may be received responsive to scanning a coupon at the POS device 110. In operation 1104, the POS device 110 may transmit the coupon code to the server 102.

In operation 404, the server 102 may receive the coupon code from the POS device 110. Once the server 102 receives the coupon code, in operation 406, the server 102 determines if the received coupon code is fraudulent or valid as described above in accordance with FIG. 10. If the received coupon code is fraudulent, then in operation 408, the server 102 generates an alert signal/message. Further, the server 102 may generate an alert signal/message if the received coupon code does not match both the list of valid and the fraudulent coupons in the database. In addition, the server 102 may generate an alert signal/message if the received coupon code matches a flagged coupon code.

Once the alert signal/message is generated, in operation 410, the server 102 transmits the alert signal/message to the POS device 110. The server 102 may transmit the alert signal/message to the fraud tracking entity, policing entity and/or personnel in a retail store associated with the POS device 110. In operation 1106, the POS device 110 receives the alert signal/message and notifies a cashier or attendant through various means such as display, auditory, tactile and/or olfactory. The process of fraud detection ends at operation 1108.

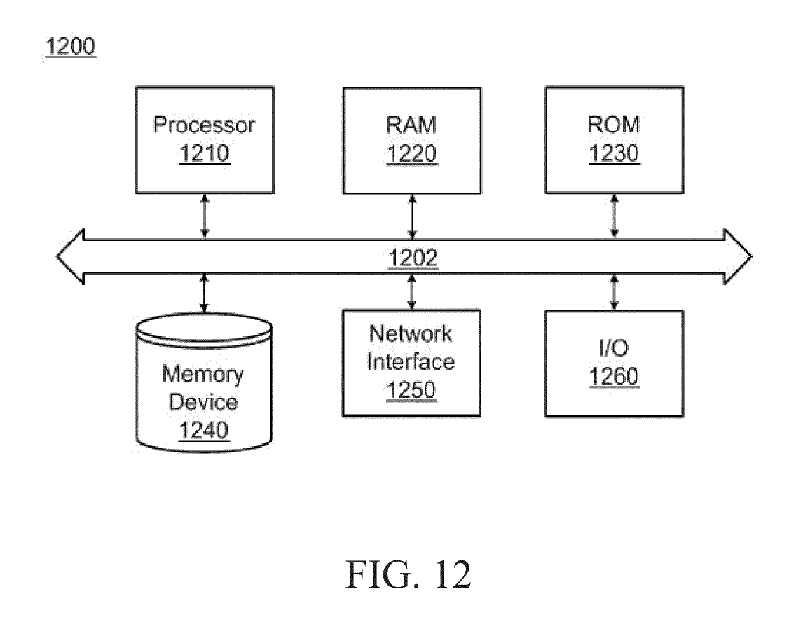

Turning to FIG. 12, FIG. 12 illustrates an example hardware diagram of a general purpose computer 1200, according to certain exemplary embodiments of the present invention. The server 102 and the POS device 110 may be implemented using combinations of one or more of the elements of the general purpose computer 1200. The computer 1200 includes a processor 1210, a Random Access Memory (RAM) 1220, a Read Only Memory (ROM) 1230, a memory (i.e., storage) device 1240, a network interface 1250, and an Input Output (I/O) interface 1260. The elements of the computer 1200 are communicatively coupled via a bus 1202.

The processor 1210 comprises any well known general purpose arithmetic processor. Both the RAM 1220 and the ROM 1230 comprise well known random access and read only memory devices, respectively, that store computer-readable instructions to be executed by the processor 1210. The memory device 1240 stores computer-readable instructions thereon that, when executed by the processor 1210, direct the processor 1210 to execute various aspects of the present invention described herein. As a non-limiting example group, the memory device 1240 may comprise one or more of an optical disc, a magnetic disc, a semiconductor memory (i.e., a flash based memory), a magnetic tape memory, a removable memory, combinations thereof, or any other well known memory means for storing computer-readable instructions. The I/O interface 1260 comprises device input and output interfaces such as keyboard, pointing device, display, communication, and other interfaces. The bus 1202 electrically and communicatively couples the processor 1210, the RAM 1220, the ROM 1230, the memory device 1240, the network interface 1250, and the I/O interface 1260, so that data and instructions may be communicated among the processor 1210, the RAM 1220, the ROM 1230, the memory device 1240, the network interface 1250, and the I/O interface 1260. In operation, the processor 1210 is configured to retrieve computer-readable instructions stored on the memory device 1240, the ROM 1230, or another storage means, and copy the computer-readable instructions to the RAM 1220 for execution. The processor 310 is further configured to execute the computer-readable instructions to implement various aspects and features of the present invention described herein.

In an example embodiment, John Doe (e.g., a customer) may acquire a coupon (e.g., a paper coupon) from a newspaper. In one embodiment, the coupon may be presented in a magazine or any other appropriate print media. Further, the coupon may be presented digitally such that the coupon can be downloaded and printed. In one embodiment, John Doe may acquire the coupon by capturing an image of the coupon using his smart phone which may be presented at a POS device to redeem the value of the coupon.

The coupon may include an identifier, such as a UPC of the coupon and a trigger item code of the coupon. In this example, the UPC of the coupon may be ‘7890165432’, and the trigger item codes may be ‘7890123456’ and ‘7890198765’. In the example, ‘78901’ may be the manufacturer code associated with the UPC of the coupon and ‘654’ may be the family code associated with the UPC of the coupon. Further, the coupon may provide $X off on a candy bar.

Once John Doe has acquired the coupon, John Doe may go to a store to purchase a candy bar to redeem the value of the coupon. In the store, John Doe may fill a shopping cart with all the products and the candy bar that John Doe intends to buy. Then, John Doe may proceed to the checkout counter that has the POS device 110. The POS device 110 may either be a cash register manned by a cashier or a self checkout counter operated by John Doe himself.

Once at the POS device 110, John Doe may be directed by the cashier or by a display of the self checkout POS device to scan the products and/or the coupon. The order of scanning may be based on the configuration of each POS device 110. For example, some POS devices may require the coupon to be scanned before the product is scanned. In another example, the POS device may require all the products in the basket to be scanned before the coupon is scanned. In either of the conditions, John Doe eventually ends up scanning the product. Each product may have UPC associated with the product. In this example, the UPC of the candy bar may be ‘7890123456’. In this example, the manufacturer code associated with the product code is ‘78901’ and the family code is ‘234’. Once John Doe scans the candy bar, the POS device 110 may transmit the UPC ‘7890123456’ of the candy bar to the server 102. In one embodiment, the POS device 110 may transmit the UPC of the candy bar at any given time during the transaction.

Once the server 102 receives the UPC ‘7890123456’ of the product, the nomination module 204 of the server 102, compares the UPC of the product to identifiers of a plurality of fraudulent coupon. The identifier of the fraudulent coupon may include a UPC of the fraudulent coupon and/or the trigger item code of the fraudulent coupon. For example, ‘7890165432’ may be the UPC of the fraudulent coupon stored in the fraudulent coupon database 208. Further, the trigger item code associated with the fraudulent coupon may be ‘1234567890’. In some embodiments, the fraudulent coupon database 208 may not include the trigger item code of the fraudulent coupon. In this example, we focus on one entry of the database. However, the database may have numerous other entries.

The server 102 compares the product code with the trigger item code of the fraudulent coupon and since the product code does not match the trigger item, the server checks the manufacturer code associated with the product code. Further, the server 102 compares the manufacturer code ‘78901’ associated with the UPC of the candy bar to the manufacturer code ‘78901’ associated with the UPC of the fraudulent coupon. Since the manufacturer codes match, the server, retrieves the UPC of the fraudulent coupon i.e., ‘7890165432’ and transmits the UPC of the fraudulent coupon to the POS device 110 in near real-time. In one embodiment, if the manufacturer codes do not match, then the server may have continued with operations 814 to operation 822 as described in FIG. 8.

Once the POS device 110 receives the UPC of the fraudulent coupon, the POS device 110 may store the UPC of the fraudulent coupon in a memory of the POS device 110. Further after scanning the products in the shopping basket, John Doe may scan the coupon he acquired from the newspaper. Responsive to John Doe scanning the coupon, the POS device 110 compares the UPC of the scanned coupon i.e., ‘7890165432’ with the UPC of the fraudulent coupon stored in the memory i.e., ‘7890165432’. Upon determining that the UPC of the fraudulent coupon and the UPC of the scanned coupon matches, the POS device 110 may generate an alert signal. The alert signal may trigger a light to flash on the POS device, or it may trigger a siren and stop a transaction. In addition, the POS device 110 may send the alert signal to a fraud tracking agency and or other appropriate entities. Further, the POS device 110 may send the alert signal to a number of store personnels via email, SMS, MMS, etc. In another embodiment, the POS device 110 can even update a Twitter feed.

In another embodiment, if the UPC of the coupon does not match the UPC of the fraudulent coupon at the POS device 110, then John Doe may receive $X off of the candy bar using the coupon. The exemplary embodiment including John Doe is for illustrative purposes and one of ordinary skill in the art can understand and appreciate that present invention may not be construed as limited to the exemplary embodiment.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1) A computer program product embodied in a non-transitory storage medium and comprising instructions that when executed by a computer perform a method, the method comprising:
receiving, by the computer, a product code associated with a product;
comparing, by the computer, the product code to identifiers for a plurality of fraudulent coupons;
responsive to a match between the product code and the identifier for at least one of the fraudulent coupons, obtaining, by the computer, information about the at least one fraudulent coupon; and
transmitting, by the computer, the information about the at least one fraudulent coupon.

2) The method of claim 1, wherein the identifier of the fraudulent coupon includes
at least one of a universal product code (UPC) of the fraudulent coupon and a trigger item code associated with the fraudulent coupon.

3) The method of claim 1, wherein the product code, the UPC of the fraudulent coupon and the trigger item code of the fraudulent coupon comprises at least one of a manufacturer code and a family code.

4) The method of claim 1, wherein the step of comparing comprises comparing the product code to the trigger item code of the fraudulent coupon.

5) The method of claim 1, wherein the step of comparing comprises comparing the manufacturer code associated with the product code to the manufacturer code associated with the UPC of the fraudulent coupon.

6) The method of claim 1, wherein the step of comparing comprises comparing the family code associated with the product code to the family code associated with the UPC of the fraudulent coupon.

7) The method of claim 1, further comprising:
comparing, by the computer, the product code to identifiers for a plurality of valid coupons;
responsive to a match between the product code and the identifier for at least one of the valid coupons, obtaining, by the computer, information about the at least one valid coupon; and
transmitting, by the computer, the information about the at least one valid coupon.

8) The method of claim 1:
wherein the computer receives the product code from a POS device,
wherein the computer transmits the information about the at least one fraudulent coupon to the POS device, and
wherein the information about the at least one fraudulent coupon comprises the UPC of the at least one fraudulent coupon.

9) The method of claim 1, further comprising:
receiving, at the computer, the information associated with the fraudulent coupon, wherein the information associated with the fraudulent coupon is received from a coupon fraud tracking entity;
populating, by the computer, the information associated the fraudulent coupon to a fraudulent coupon database; and.
updating, by the computer, the fraudulent coupon database at predetermined time intervals.

10) The method of claim 1, further comprising:
receiving, at the computer, the information associated with the valid coupon, wherein the information associated with the valid coupon is received from at least one of a retailer, an entity that issues the coupon, and a manufacturer;
populating, by the computer, the information associated the valid coupon to a valid coupon database, wherein the UPC of the valid coupon and the trigger item code of the valid coupon comprises at least one of a manufacturer code and a family code; and
providing, by the computer, a web interface to access and update the valid coupon database.

11) The method of claim 10 wherein the information associated with the valid coupon comprises at least one of a UPC of the valid coupon and a trigger item code associated with the valid coupon.

12) The method of claim 9 wherein the information associated with the fraudulent coupon comprises at least one of the UPC of the fraudulent coupon and the trigger item code of the fraudulent coupon.

13) The method of claim 8:
wherein the POS device stores the information about the at least one fraudulent coupon in a memory of the POS device,
wherein the POS device receives a UPC of a coupon,
wherein the POS device compares the UPC of the coupon with the information about the at least one fraudulent coupon that is received from the computer, and
wherein the POS device generates an alert responsive to a match between the UPC of the coupon and the information about the at least one fraudulent coupon.

14) A computer, comprising:
a memory; and
a processor configured to:
receive a product code associated with a product;
compare the product code to identifiers for a plurality of fraudulent coupons;
responsive to a match between the product code and the identifier for at least one of the fraudulent coupons, obtain information about the at least one fraudulent coupon; and
transmit the information about the at least one fraudulent coupon.

15) The computer of claim 14:
wherein the identifier of the fraudulent coupon includes at least one of a universal product code (UPC) of the fraudulent coupon and a trigger item code associated with the fraudulent coupon, and
wherein the product code, the UPC of the fraudulent coupon and the trigger item code of the fraudulent coupon comprises at least one of a manufacturer code and a family code.

16) The computer of claim 14, wherein the processor is configured to compare the product code with a trigger item code of the fraudulent coupon.

17) The computer of claim 14, wherein the processor is configured to compare the manufacturer code associated with the product code with the manufacturer code associated with the UPC of the fraudulent coupon.

18) The computer of claim 14, wherein the processor is configured to compare the family code associated with the product code with the family code associated with the UPC of the fraudulent coupon.

19) A system, comprising:
a computer configured to:
receive the information associated with the fraudulent coupon;
populating the information associated the fraudulent coupon to a fraudulent coupon database;
receive the information associated with the valid coupon;
populating the information associated the valid coupon to a valid coupon database;
receive a product code associated with a product;
compare the product code to identifiers for a plurality of fraudulent coupons stored in the fraudulent coupon database;
responsive to a match between the product code and the identifier for at least one of the fraudulent coupons, obtain information about the at least one fraudulent coupon from the fraudulent coupon database; and
transmit the information about the at least one fraudulent coupon.

20) system of claim 19:
wherein the information associated with the fraudulent coupon is received from a coupon fraud tracking entity,
wherein the information associated with the valid coupon is received from at least one of a retailer, an entity that issues the coupon, and a manufacturer,
wherein the information associated with the valid coupon comprises at least one of a UPC of the valid coupon and a trigger item code associated with the valid coupon, and
wherein the information associated with the fraudulent coupon comprises at least one of the UPC of the fraudulent coupon and the trigger item code of the fraudulent coupon.

21) The system of claim 19, wherein the computer is configured to compare the product code with a trigger item code of the fraudulent coupon.

22) The method of claim 19, wherein the computer is configured to compare a manufacturer code associated with the product code with a manufacturer code associated with the UPC of the fraudulent coupon.

23) The method of claim 19, wherein the computer is configured to compare a family code associated with the product code with a family code associated with the UPC of the fraudulent coupon.
